(19) United States
(12) Patent Application Publication
(10) Pub. No.: US 2017/0047062 A1
(43) Pub. Date: Feb. 16, 2017

(54) BUSINESS NAME PHONETIC OPTIMIZATION METHOD

(71) Applicant: Panasonic Automotive Systems Company of America, Division of Panasonic Corporation of North America, PEACHTREE CITY, GA (US)

(72) Inventor: JOHN LUKE HOLDREN, FERNDALE, MI (US)

(73) Assignee: Panasonic Automotive Systems Company of America, Division of Panasonic Corporation of North America

(21) Appl. No.: 15/229,514

(22) Filed: Aug. 5, 2016

Related U.S. Application Data
(60) Provisional application No. 62/205,013, filed on Aug. 14, 2015.

(51) Int. Cl. G10L 15/10; G10L 25/51; G10L 15/22; G10L 13/02; G10L 15/06; G10L 15/02; G10L 15/30

(52) U.S. Cl. CPC G10L 15/10; G10L 15/02; G10L 25/51; G10L 15/30; G10L 13/02; G10L 15/063; G10L 15/22; G10L 2015/025; G10L 2015/0631

(57) ABSTRACT

A method of providing text to speech conversion in an automobile includes receiving a command from a user regarding an organization. First information is received from an electronic mobile device within the vehicle. The first information regards the organization. Second information is retrieved from an information source that is remote from the vehicle. The retrieving is dependent upon the first information. The remote information source may include a satellite radio signal provider or a navigation information provider, for example. The second information includes pronunciation information about a name of the organization. An audible pronunciation of the organization name is provided by use of electronic speech within the vehicle. The pronunciation of the organization name is dependent upon the pronunciation information retrieved from the remote information source.

### CROSS-REFERENCED TO RELATED APPLICATIONS

This application claims benefit of U.S. Provisional Application No. 62/205,013 filed on Aug. 14, 2015, which the disclosure of which is hereby incorporated by reference in its entirety for all purposes.

### FIELD OF THE INVENTION

The disclosure relates to a voice recognition (VR) system or a text to speech (TTS) for a motor vehicle.

### BACKGROUND OF THE INVENTION

Currently, embedded VR engines struggle to provide adequate user experiences when attempting to recognize small chain business names, e. g., the name of a business that does not meet the criteria of a chain. The phonetic information for such businesses is rendered using standard grapheme-to-phoneme (G2P) rules and may, as a result, degrade recognition performance, and/or provide text to speech (TTS) renderings that are of a lower quality than the renderings provided with custom pronunciation rule sets. Additionally, the systems do not have dynamic synonym dictionaries. Synonyms must be provided by an exception dictionary built in to the embedded VR engine. Plainly put, when an automotive head unit parses the phone book data from the phone, it does no further checking of the data.

A known method for creating G2P data from phone book contacts is as follows: First, a user pairs and connects a phone to the head unit. Second, the user accepts the request from the head unit for phone book access, thus allowing the head unit to parse the data from the phone book, usually in vCard format. Third, the embedded VR engine uses standard and custom Common Linguistic Components (CLCs) to generate phonetic transcriptions through a G2P process. This process does not, however, verify the correctness of a phone number or generate synonyms for the contact.

### SUMMARY

Through the use of a multi-step approach, the present invention supplements a VR system's ability to correctly recognize phone book entries corresponding to local businesses. The phone book entries may not be included as a part of the standard pronunciation dictionary used with embedded VR. The invention may also provide localized/optimized TTS renderings.

By the inventive system searching the head unit's databases, alternative transcriptions can be found and exploited. Through this process, the system may both increase the number of synonyms available for a given contact and provide localized text-to-speech renderings of the names of less commonly known businesses.

Unlike currently known cloud-based implementations, which rely solely on phonetic data received from a remote server utilizing an internet data connection, or embedded systems, for which custom user dictionaries must manually be generated, the system of the present invention can also perform a check by leveraging navigation data services over a satellite radio band, such as SiriusXM, checking the point of interest (POI) metadata, such as a phone number, for a match against a connected device's contact list, and replacing the default G2P data with that of the phonetic rendering provided by the phonetics database (provided by the map data carrier and/or the satellite service provider). Thus, the present invention may provide a homogeneous phonetics user experience.

The present invention may leverage the plurality of embedded systems to increase the precision of recognition, generate recognition synonyms, and improve, through the process of localization, the computer-generated responses rendered by the text-to-speech engine.

In one embodiment, the invention comprises a method of providing text to speech conversion in an automobile, including receiving a command from a user regarding an organization. First information is received from an electronic mobile device within the vehicle. The first information regards the organization. Second information is retrieved from an information source that is remote from the vehicle. The retrieving is dependent upon the first information. The remote information sources may include, but are not limited to, a satellite radio signal provider or a navigation information provider. The second information includes pronunciation information about a name of the organization. An audible pronunciation of the organization name is provided by use of electronic speech within the vehicle. The pronunciation of the organization name is dependent upon the pronunciation information retrieved from the remote information source.

In another embodiment, the invention comprises a method of providing text to speech conversion in an automobile, including receiving a command from a user regarding an organization. Information is retrieved from an information source that is remote from the vehicle. The remote information sources may include, but are not limited to, a satellite radio signal provider or a navigation information provider. The information includes pronunciation information about a name of the organization. An audible pronunciation of the organization name is provided by use of electronic speech within the vehicle. The pronunciation of the organization name is dependent upon the pronunciation information retrieved from the remote information source.

In yet another embodiment, the invention comprises a motor vehicle including an infotainment arrangement having a microphone receiving a command from a user regarding an organization. A first wireless communication module receives first information from an electronic mobile device within the vehicle. The first information regards the organization. A second wireless communication module retrieves second information from an information source that is remote from the vehicle. The remote information sources may include, but are not limited to, a satellite radio signal provider or a navigation information provider. The second information includes pronunciation information about a name of the organization. A control module is communicatively coupled to each of the microphone, the first wireless communication module, and the second wireless communication module. The control module controls the retrieving of the second information dependent upon the first information. An audible pronunciation of the organization name is provided by use of electronic speech within the vehicle. The pronunciation of the organization name is dependent upon the pronunciation information retrieved from the remote information source.

### BRIEF DESCRIPTION OF THE DRAWINGS

A better understanding of the present invention will be had upon reference to the following description in conjunction with the accompanying drawings.

FIG. 1 is a flow chart of one example embodiment of an on demand phonetic optimization method of the present invention.

FIG. 2 is a block diagram of one example embodiment of an infotainment system of the present invention.

### DETAILED DESCRIPTION OF THE PREFERRED EMBODIMENTS

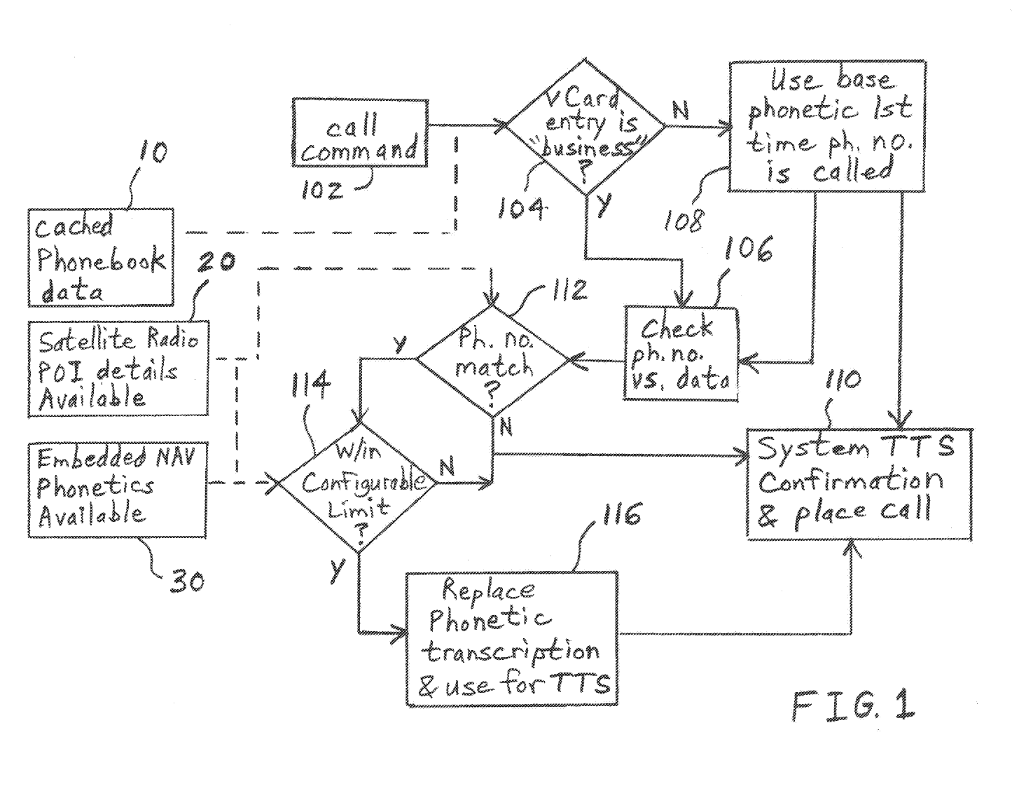

FIG. 1 illustrates one embodiment of an on demand phonetic optimization method of the present invention. System data inputs are indicated by dashed lines, and transitions between steps are indicated by solid lines. The system data includes cached phonebook data 10, such as vCard parsing and G2P information; satellite radio POI details available 20, such as phone number, business name, etc.; and embedded navigation element (NAV) phonetics available 30.

In step 102, a call command, such as “call <some contact>” is issued. Cached phonebook data 10 is received, and in step 104 it is determined whether the vCard entry in data 10 is listed as “business”. Logic may optimize a search routine trigger. If the vCard entry in data 10 is listed as “business”, then in step 106 the phone number is checked against NAV/S-band (satellite band) data, which may be regularly and wirelessly updated. However, if the vCard entry in data 10 is not listed as “business”, then in step 108 the base phonetic is used the first time the phone number is called. A background process may be created. The user might notice a difference in subsequent results. Operation then proceeds to steps 106 and 110. In step 110, the system performs a text to speech confirmation, “Calling <some_business>”, and the phone call is placed.

After step 106, operation proceeds to step 112, where it is determined whether the phone number matches the NAV/S-band data. If not, then operation proceeds to step 110. If the phone number does match the NAV/S-band data, then in step 114 data is received from databases 20, 30, and it is determined whether the vCard entry (vCard <some_business>) matches the orthography of databases 20, 30 within some configurable limit. If it does not, then the databases may not be useful in improving on the phonetics of the vCard entry, and operation proceeds to step 110. If the vCard entry does match the orthography of databases 20, 30 within some configurable limit, then operation proceeds to step 116, where the phonetic transcription in the user data is replaced based on the system data, and the updated phonetic transcription is used for text to speech the first time the phone number is called. Operation then proceeds to step 110.

In the method depicted in FIG. 1, it is assumed that the confidence score returned by the voice recognition engine is above the medium confidence result (MCR)/high confidence result (HCR) threshold and all confirmation steps have been performed. Put simply, the voice recognition session may produce an ideal result.

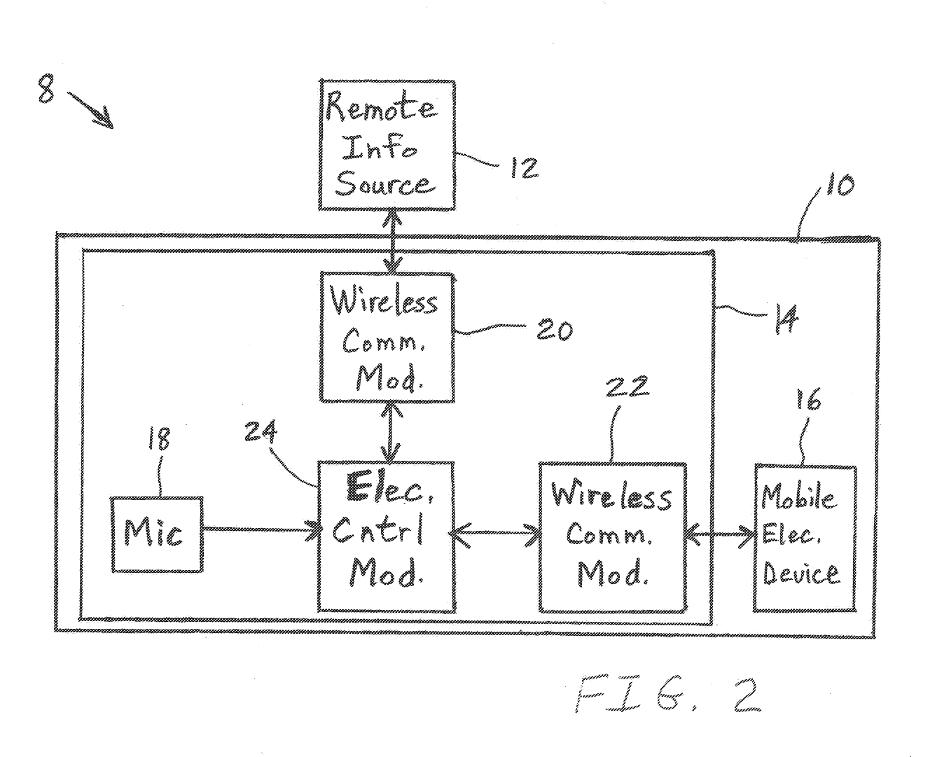

FIG. 2 illustrate one example embodiment of an infotainment system 8 of the present invention, including a motor vehicle 10 and a remote information source 12. Vehicle 10 includes a vehicle infotainment arrangement 14, and a passenger's mobile electronic device 16 is disposed within vehicle 10. Vehicle infotainment arrangement 14 includes a microphone 18, wireless communication modules 20, 22, and an electronic control module 24.

Microphone 18 may receive an oral command from a user regarding an organization, such as a business. For example, the user may ask for the address of the organization.

Wireless communication module 22 may receive information from electronic mobile device 16 within vehicle 10. The information may be about the organization, such as its address or telephone number, for example. The information may be a vCard associated with the organization

The other wireless communication module 20 may retrieve information from information source 12, which is disposed remote from vehicle 10. The information may include pronunciation information about a name of the organization.

Electronic control module 24 may be communicatively coupled to each of microphone 18, the wireless communication modules 20, 22. Control module 24 may control the retrieving of the information from information source 12 dependent upon the information from electronic mobile device 16.

Electronic control module 24 may also provide an audible pronunciation of the organization name by use of electronic speech and a loudspeaker (not shown) within vehicle 10. The pronunciation of the organization name may be dependent upon the pronunciation information retrieved from remote information source 12.

Control module 24 may determine whether the information source 12 correlates with the information from electronic mobile device 16 more than a threshold degree. The pronunciation of the organization name may be dependent upon the pronunciation information retrieved from remote information source 12 only if the information from information source 12 correlates with the information from electronic mobile device 16 more than the threshold degree. The pronunciation of the organization name may be dependent upon base phonetic information if the information from remote information source 12 does not correlate with the information from electronic mobile device 16 more than the threshold degree.

Control module 24 may store the pronunciation information retrieved from remote information source 12 within vehicle 10 or within electronic mobile device 16. Remote information source 12 may be a satellite radio signal provider or a navigation information provider.

The invention has been described above as being applied to text to speech processes. However, it is to be understood that the invention may also be applied to voice recognition processes.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A method of providing text to speech conversion in an automobile, the method comprising:
receiving a command from a user regarding an organization;
receiving first information from an electronic mobile device within the vehicle, the first information regarding the organization;
retrieving second information from an information source that is remote from the vehicle, the retrieving being dependent upon the first information, the second information including pronunciation information about a name of the organization; and
providing an audible pronunciation of the organization name by use of electronic speech within the vehicle, the pronunciation of the organization name being dependent upon the pronunciation information retrieved from the remote information source.

2. The method of claim 1 wherein the organization comprises a business.

3. The method of claim 1 wherein the command is a command for the electronic mobile device to place a telephone call to the organization.

4. The method of claim 1 wherein the first information comprises a vCard associated with the organization.

5. The method of claim 1 comprising the further step of determining whether the second information correlates with the first information more than a threshold degree, the pronunciation of the organization name being dependent upon the pronunciation information retrieved from the remote information source only if the second information correlates with the first information more than the threshold degree, and the pronunciation of the organization name being dependent upon base phonetic information if the second information does not correlate with the first information more than the threshold degree.

6. The method of claim 1 comprising the further step of storing the pronunciation information retrieved from the remote information source within the automobile.

7. The method of claim 1 comprising the further step of storing the pronunciation information retrieved from the remote information source within the electronic mobile device.

8. The method of claim 1 wherein the remote information source comprises a satellite radio signal provider or a navigation information provider.

9. A method of providing text to speech conversion in an automobile, the method comprising:
receiving a command from a user regarding an organization;
retrieving information from an information source that is remote from the vehicle, the information including pronunciation information about a name of the organization; and
providing an audible pronunciation of the organization name by use of electronic speech within the vehicle, the pronunciation of the organization name being dependent upon the pronunciation information retrieved from the remote information source.

10. The method of claim 9 wherein the organization comprises a business.

11. The method of claim 9 wherein the command is a command for the electronic mobile device to place a telephone call to the organization.

12. The method of claim 9 wherein the information comprises a vCard associated with the organization.

13. The method of claim 9 comprising the further step of storing the pronunciation information retrieved from the remote information source within the automobile.

14. The method of claim 9 comprising the further step of storing the pronunciation information retrieved from the remote information source within the electronic mobile device.

15. The method of claim 9 comprising the further step of receiving information regarding the organization from an electronic mobile device within the vehicle, the retrieving being dependent upon the information regarding the organization from the electronic mobile device.

16. The method of claim 15 wherein the pronunciation of the organization name is dependent upon the pronunciation information retrieved from the remote information source only if the information retrieved from the remote information source correlates with the information from the electronic mobile device more than a threshold degree, and the pronunciation of the organization name being dependent upon base phonetic information if the information retrieved from the remote information source does not correlate with the information from the electronic mobile device more than the threshold degree.

17. The method of claim 9 wherein the remote information source comprises a satellite radio signal provider or a navigation information provider.

18. A motor vehicle, comprising an infotainment arrangement including:
a microphone configured to receive a command from a user regarding an organization;
a first wireless communication module configured to receive first information from an electronic mobile device within the vehicle, the first information regarding the organization;
a second wireless communication module configured to retrieve second information from an information source that is remote from the vehicle, the second information including pronunciation information about a name of the organization; and
an electronic control module communicatively coupled to each of the microphone, the first wireless communication module, and the second wireless communication module, the control module being configured to:
control the retrieving of the second information dependent upon the first information, and
provide an audible pronunciation of the organization name by use of electronic speech within the vehicle, the pronunciation of the organization name being dependent upon the pronunciation information retrieved from the remote information source.

19. The vehicle of claim 18 wherein the first information comprises a vCard associated with the organization.

20. The vehicle of claim 18 wherein the control module is configured to determine whether the second information correlates with the first information more than a threshold degree, the pronunciation of the organization name being dependent upon the pronunciation information retrieved from the remote information source only if the second information correlates with the first information more than the threshold degree, and the pronunciation of the organization name being dependent upon base phonetic information if the second information does not correlate with the first information more than the threshold degree.

21. The vehicle of claim 18 wherein the control module is configured to store the pronunciation information retrieved from the remote information source within the vehicle.

22. The vehicle of claim 18 wherein the control module is configured to store the pronunciation information retrieved from the remote information source within the electronic mobile device.

23. The vehicle of claim 18 wherein the remote information source comprises a satellite radio signal provider or a navigation information provider.
